(19) United States
(12) Patent Application Publication
(10) Pub. No.: US 2017/0371864 A1
(43) Pub. Date: Dec. 28, 2017

(54) SYSTEM AND METHOD FOR DEVICE FILTERED TRANSLATION

(71) Applicants: Kabushiki Kaisha Toshiba, Minato-ku (JP); Toshiba TEC Kabushiki Kaisha, Shinagawa-ku (JP)

(72) Inventor: Milong Sabandith, Irvine, CA (US)

(21) Appl. No.: 15/191,977

(22) Filed: Jun. 24, 2016

(51) Int. Cl. G06F 17/28; G06K 9/00; G06F 17/22; H04N 1/00

(52) U.S. Cl. CPC G06F 17/289; H04N 1/00244; G06K 9/00993; G06F 17/2288; H04N 1/00344; G06K 2209/01; H04N 2201/0039; H04N 2201/0094

(57) ABSTRACT

A system and method for electronic document translation filtering includes an input that receives electronic document data and instruction data corresponding to at least one document processing operation to be performed on the electronic document data. A computer includes a processor and associated memory identifies a language associated with the electronic document data and receives a translation instruction corresponding to at least one target language. The computer applies language filter data specified by the translation instruction to the electronic document data to generate translated electronic document data. A translated electronic document resultant from application of the language filter data to the electronic document data is stored and an output communicates the translated electronic document data to a document processing engine.

### TECHNICAL FIELD

This application relates generally to document processing via device filters. The application relates more particularly to management and application of document processing device operations to accomplish translation by employing filters during document processing operations.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Users may send document processing jobs, such as a print request, to one or more networked devices. In a typical shared device setting, one or more workstations are connected via a network. When a user wants to print a document, an electronic copy of that document is sent to a document processing device via the network. The user may select a particular device when several are available. The user then walks to the selected device and picks up their job or waits for the printed document to be output. If multiple users send their requests to the same device, the jobs are queued and outputted sequentially.

User devices have become increasingly mobile. Often times users interact with MFPs via portable notebook computers, or via handheld devices such as tablet computers, smartphones, or the like. A user may install a driver on their device to allow for printing of documents on available devices. Electronic documents for printing may be comprised of formats such as a Microsoft Word file, a portable document format “PDF” file, a Tagged Information Format File (TIFF) file, or any other suitable text, vector or image file format. A print driver is a piece of software that converts such data to a form specific to a particular printer. This allows applications to print files without having to be customized for any particular printer type. A print driver functions to accurately translate an electronic document so that it is reproduced accurately on the rendering device. An optimal driver will generate, for example, a paper rendering that is identical to a corresponding image on a display terminal.

### SUMMARY

In accordance with an example embodiment of the subject application, a system and method for electronic document translation filtering includes an input that receives electronic document data and instruction data corresponding to at least one document processing operation to be performed on the electronic document data. A computer includes a processor and associated memory identifies a language associated with the electronic document data and receives a translation instruction corresponding to at least one target language. The computer applies language filter data specified by the translation instruction to the electronic document data to generate translated electronic document data. A translated electronic document resultant from application of the language filter data to the electronic document data is stored and an output communicates the translated electronic document data to a document processing engine.

### BRIEF DESCRIPTION OF THE DRAWINGS

Various embodiments will become better understood with regard to the following description, appended claims and accompanying drawings wherein:

FIG. 1 an example embodiment of a networked document rendering system;

FIG. 2 is an example embodiment of a document rendering system;

FIG. 3 is an example embodiment of a digital device system;

FIG. 4 is an example embodiment of a filter system;

FIG. 5 is an example embodiment of a flowchart; and

FIG. 6 is an example embodiment of an electronic document rendering.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Printing of documents from computing devices, including portable computers, tablet computers and smartphones, is ubiquitous. In many instances, a person need only download and install the appropriate driver for a particular printing device, or family of printing devices. The user then selects a particular printer/driver and sends the document for printing. The user may then go the destination printer and retrieve a printout. The electronic document that is printed is suitably disposed on the user's device. However, the document may also exist on a networked device such as a file server, workstation or cloud storage. In these instances, a document is suitably retrieved and passed through a driver on the user's device on the way to one or more designated printers. In each instance, the rendered document will accurately mirror the precise text of the original electronic document.

More recently, widespread adoption of the global Internet has given individuals ready access to documents around the world. Online searching of topics of interest may turn up websites in many different languages. Online tools are available that facilitate machine translation of websites. While these are typically less-than-perfect translations, they may be sufficiently accurate to allow one to determine whether a particular site is of interest. A user may happen across a relevant site that is itself a repository for downloadable documents that are also relevant. If a user prints out one of these documents, it would still be incumbent on them to find a way to translate the printed document. This is but one example of situations when it may be desirable to print out an electronic document in a translated language.

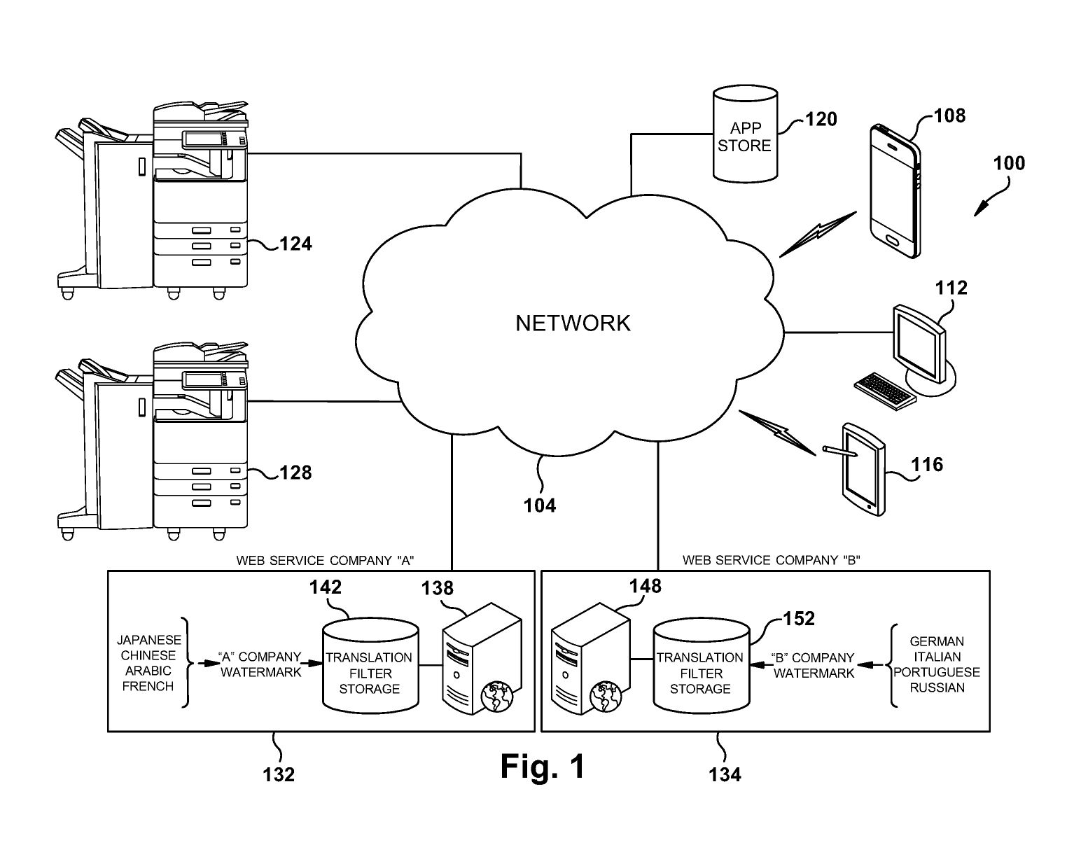

In accordance with the subject application, FIG. 1 illustrates an example embodiment of a networked document rendering system 100 that addresses the areas noted above. More particularly, the illustrated example provides a system 100 for quickly and efficiently generating rendered documents that are automatically translated during a printing operation. Network 104 is suitably comprised of a local area network (LAN), wide area network (WAN) or the global Internet, alone or in combination. Digital devices such as smartphone 108, workstation 112 or tablet computer 116 are in wired or wireless data communication with network 104. It will be appreciated that any suitable digital device can be used, such as a notebook computer, laptop computer, embedded computer or the like.

In the example embodiment of FIG. 1, networked cloud-based or server-based storage 120 facilitates online storage and retrieve of textual, image, graphic or other encoded electronic documents, as well as any other suitable digital file including application programs. Storage 120 may comprise online software repositories for download, which download may be at no charge or for a fee. Suitable examples include the Apple App Store, Apple iTunes or Google Play. Suitably stored in storage 120 are downloadable language translation filters which can be downloaded into a user's digital device, suitably on demand. Translation filters are suitably associated with a printer drive for a corresponding user device document rendering operation.

Also in data communication with network 104 is one or more document processing devices such as MFPs 124 and 128, suitably implemented for rendering of electronic documents such as those that may be found on a user's digital data device or other online or networked storage. In an example embodiment, a user device may include a print driver. In the example, a user wishes to print an electronic document that is in a foreign language. The user accesses an application store and selects a filter corresponding to a source language of the electronic document and a target language familiar to the user. Once installed on the user's device and selected for use, the filter works in concert with a print driver. When a printer and its associated driver is selected and one or more electronic documents are sent for printing, the filter intercepts foreign language components of the electronic file and generates a translated counterpart which is routed to the associated printer. The tangible document that is printed is then machine translated into the target language of the filter.

Suitable filters may be supplied from different sources. By way of example, one company may provide filters for Apple products while others provide filters for Windows or Android products. Also, multiple competitors may offer different filter options. Accordingly, filters are suitably provided with watermark data indicative of a filter author, filter source or other suitable information. The watermark is suitably rendered in conjunction with a printed document. Thus, a user may associate quality levels with watermarks corresponding to a particular filter product. A watermark may also be used to provide marketing value to a filter provider. By way of further example, a watermark may result from use of filters that were downloaded and installed free of charge. If a user pays a fee, the watermark may be suspended or modified for future document renderings.

A user suitably has one or more filters available to them for each of one or more source languages and one or more target languages. While a user may select a particular filter, in another example, the filter includes sufficient intelligence to detect words, word patterns, font characteristics or other digital indicia to either automatically engage in a filtering to a target language from an identified source language. This is suitably automatic with a default target language being applied, or by preselection or by a prompted selection by the user.

In a further example embodiment of FIG. 1, one or more web service company, such as web service company A, 132 and web service company B, 134 are also in data communication with network 104. Web service company A, 132 comprises a server system 138 including local storage 142 storing one or more filters. A user suitably sends one or more electronic documents to a web service company, or alternatively directs a web service company to retrieve a document from a commonly accessible source. In this alternative, a filter is applied by the web company, and the document is either rendered directly by the web company or translated document printed at one or more targeted printers, such as MFP 124 or 126. As discussed above, each web service company suitably has one or more associated watermarks that may be embodied in a rendered document. A watermark may identify a web service company. Alternatively, a watermark may comprise paid advertising as a revenue source for the web service company. This may subsidize all or a portion of the translation and rendering services from the web service company.

Web service company B, 134, analogously to that detailed above, includes a server 148 and data storage 152. In the illustrated example, web service company A, 132 and web service company B, 134 provide translation solutions for different languages.

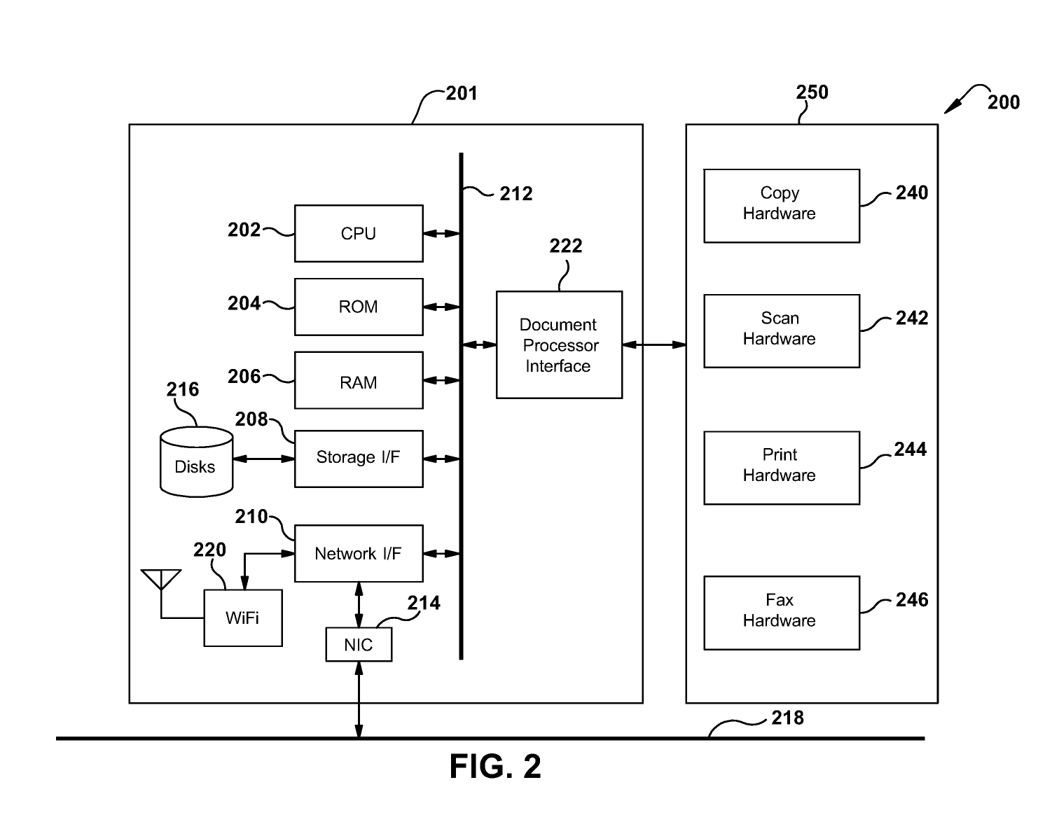

Turning now to FIG. 2, illustrated is an example of a document rendering system 200 suitably comprised within an MFP, such as with MFPs 124 and 128 of FIG. 1. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 218, or to a wireless data connection via wireless network interface 220. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. NIC 214 and wireless network interface 218 suitably provide for connection to an associated network (not shown).

Processor 202 can also be in data communication with any suitable user input/output (I/O) interface which provides data communication with user peripherals, such as displays, keyboards, mice, track balls, touch screens, or the like. Also in data communication with data bus 212 is a document processor interface 222 suitable for data communication with MFP functional units 250. In the illustrated example, these units include copy hardware 240, scan hardware 242, print hardware 244 and fax hardware 246 which together comprise MFP functional units 250. It will be understood that MFP functional units 250 are suitably comprised of intelligent units, including any suitable hardware or software platform.

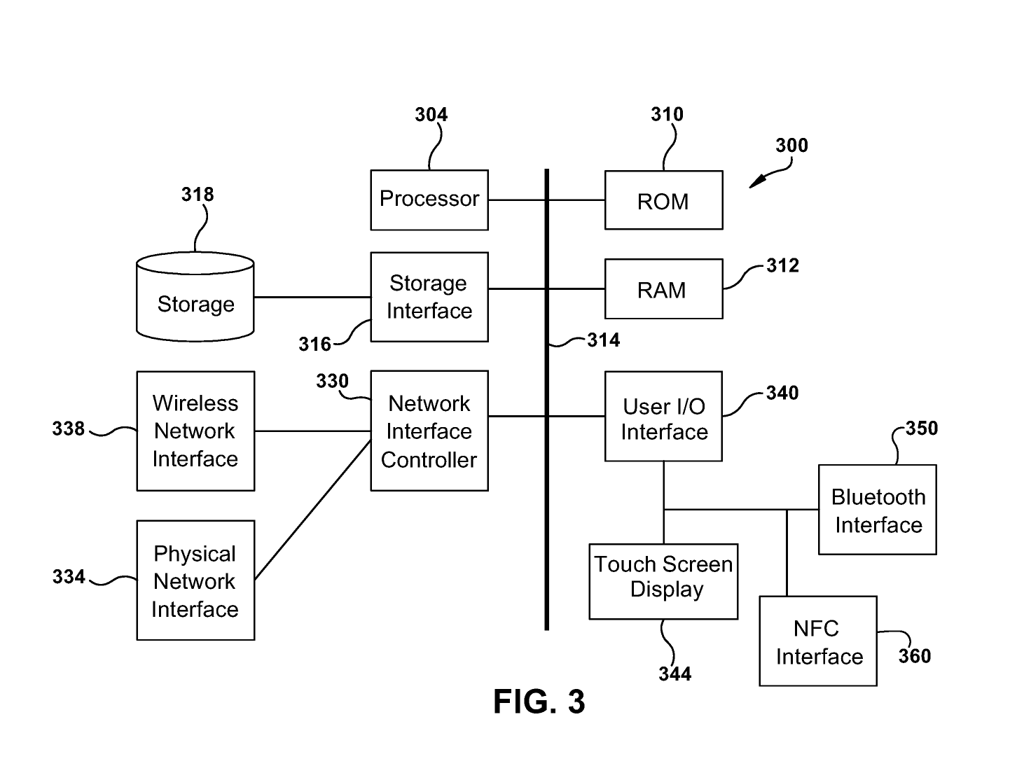

Turning now to FIG. 3, illustrated is an example of a digital device system 300 suitably comprising personal or portable data devices, such as user devices 108, 112 or 116, as well as network storage 120 or servers 138 or 148. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 316 for reading or writing to a data storage system 318, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable wired or physical network connection via physical network interface 334, or to any suitable wireless data connection via wireless network interface 338. Example wireless connections include cellular, Wi-Fi, Bluetooth, NFC, wireless universal serial bus (wireless USB), satellite, and the like. Example wired interfaces include Ethernet, USB, IEEE 1394 (FireWire), telephone line, or the like.

Processor 304 is also in data communication with a user input/output (I/O) interface 340 which provides data communication with user peripherals, such as display 344, Bluetooth interface 350, or near-field communication interface 360, as well as keyboards, mice, track balls, touch screens, or the like. It will be understood that functional units are suitably comprised of intelligent units, including any suitable hardware or software platform.

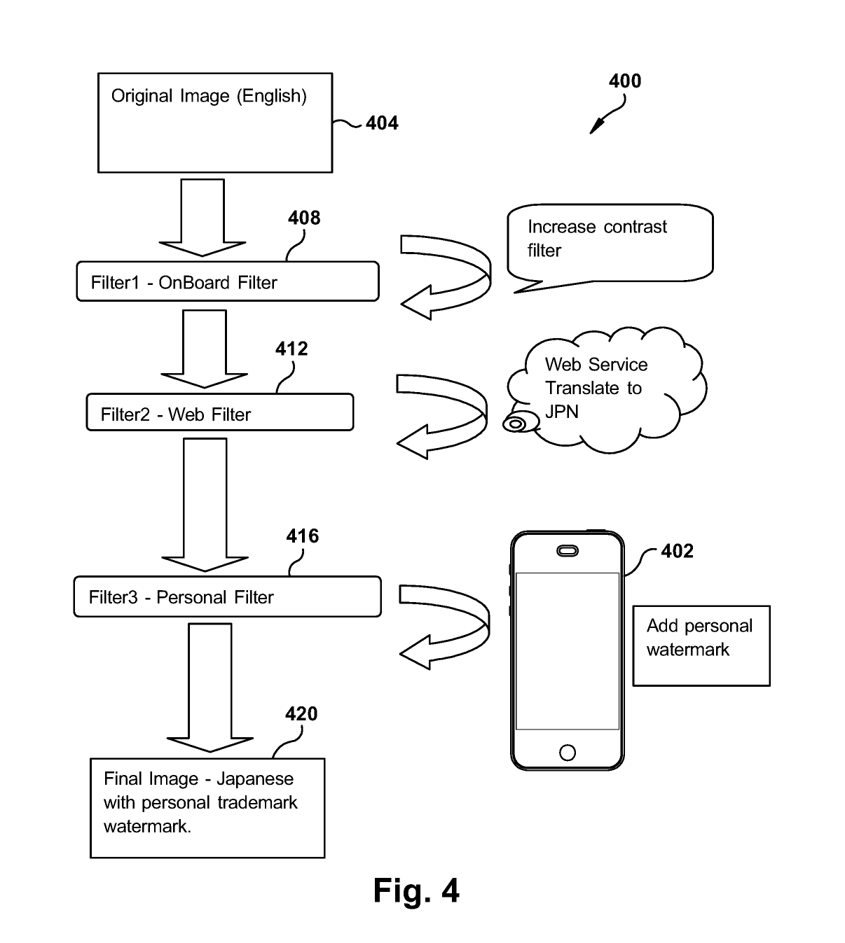

Referring next to FIG. 4, illustrated is an example embodiment of a filter system 400 for language translation, suitably configured for use with a data device such as smartphone 402. An original electronic document is comprised of image data 404 in English. Onboard filter 408 functions to increase contrast of an image represented by the image data file 404. The image file is suitably subject to optical character recognition which may be more accurately accomplished with an image with enhanced contrast. Next a web filter 412 is applied to the electronic document. This is suitably done on the data device itself with an installed filter, or completed by a web service as detailed above. Next, a personal watermark may be applied to the translated electronic document at filter 416 resulting in a final, translated image data file 420 in Japanese.

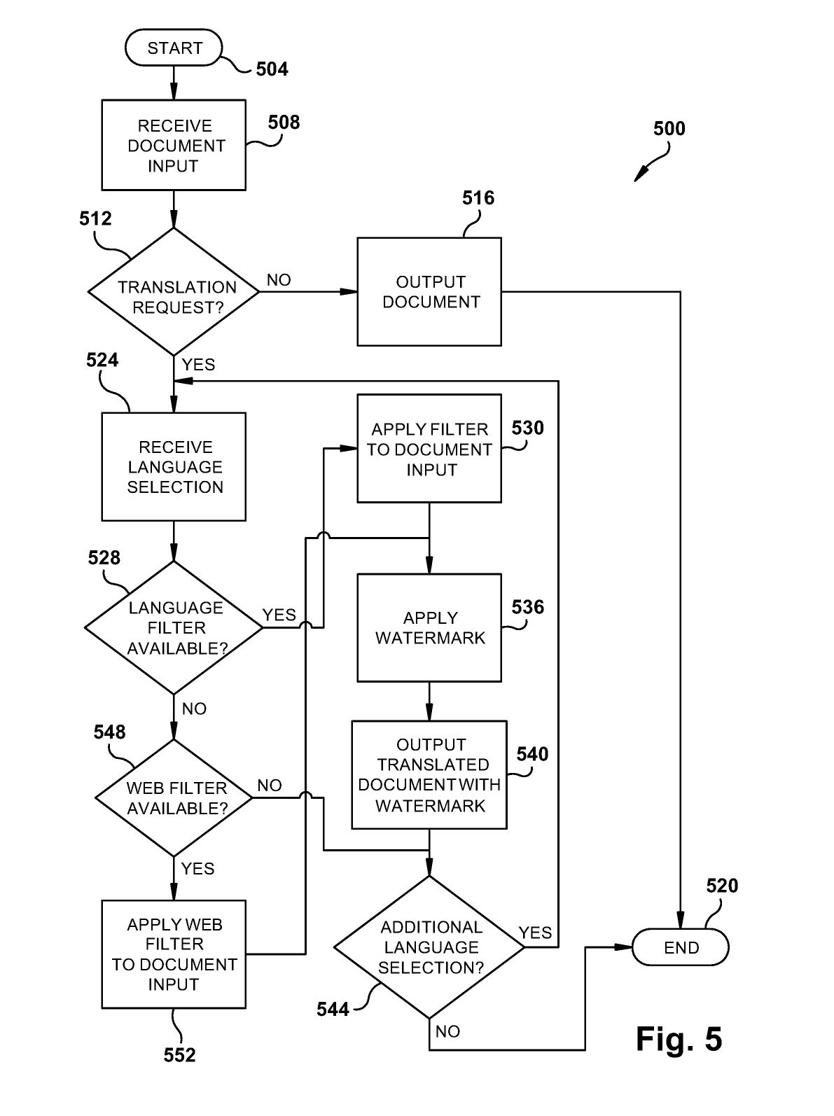

FIG. 5 is an example embodiment of flowchart 500 for completing a filtered translation operation. The operation commences at block 504 and electronic document input is received at block 508. A determination is made at block 512 as to whether a translation is desired. If not, the document is output or rendered at block 516 and the process ends at block 520. If a translation is requested, a language selection is received at block 524 and a determination is made at block 528 as to whether a filter for the selected language is available. If so, the filter is applied at block 530 and a corresponding watermark is applied at block 536. The translated electronic document is output or rendered at block 540. A determination is made at block 544 as to whether an additional language translation is desired. If not, the process ends at block 520. If so, the process returns to block 524.

If a determination is made at block 528 that a language filter is not available, a determination is made at block 548 as to whether a web filter, either a downloadable filter or a web filter service, is available. If so, the corresponding filter is applied to the electronic document at block 552 and the process proceeds to block 536. If not, the process progresses to block 544 and then proceeds as discussed above.

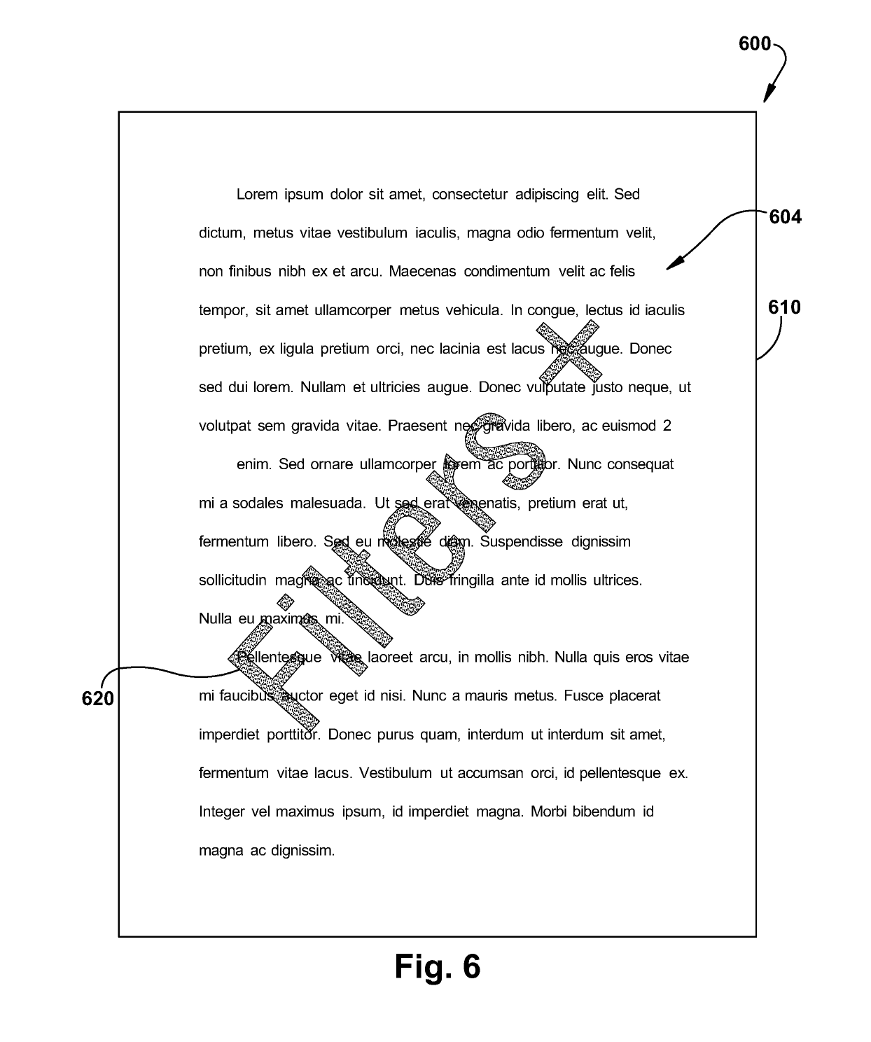

FIG. 6 is example embodiment of an electronic document rendering 600 such as a result of application of a translation filter. Translated text 604 is provided on page 610. Watermark 620, such as watermarking described above, is suitably superimposed over text 604. It will be appreciated that any suitable watermark 620 may be used, such as a trademark, tradename, fanciful designation, image, logo and the like. Also, placement is suitably accomplished at any position and orientation on one or more pages of a rendered, translated document.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
an input configured to receive electronic document data, the input configured to receive instruction data corresponding to at least one document processing operation to be performed on the electronic document data;
a computer including a processor and associated memory, the computer configured to identify a language associated with the electronic document data, the computer configured to receive a translation instruction corresponding to at least one target language, the computer configured to apply language filter data specified by the translation instruction to the electronic document data to generate translated electronic document data, and the memory configured to store translated electronic document data resultant from application of the language filter data to the electronic document data; and
an output configured to communicate the translated electronic document data to a document processing engine.

2. The system of claim 1 wherein the computer is comprised of a multifunction peripheral controller, and
wherein the input and the output is comprised of a network interface.

3. The system of claim 1 wherein the computer is comprised of a portable data device, and
wherein the input and the output is comprised of a wireless data interface.

4. The system of claim 1 wherein the computer is comprised of a web server, and
wherein the input and the output is comprised of a network interface.

5. The system of claim 3 further comprising:
a web server including a processor, memory and a data interface configured for data communication with the wireless data interface,
wherein the web server is further configured to locally store data corresponding to at least one language filter,
wherein the web server is further configured to receive electronic document data from the portable data device,
wherein the web server is further configured to receive a translation instruction from the portable data device,
wherein the web server is further configured to apply locally stored language filter data specified by the translation instruction to the electronic document data, and
wherein the data interface is configured to communicate translated electronic document data resultant from application of the locally stored filter data to the electronic document data to the document processing engine with watermark data corresponding to the web server.

6. The system of claim 5 further comprising a multifunction peripheral comprising the document processing engine, the multifunction peripheral comprising:
a controller including a processor and memory; and
a network interface, and
wherein the document processing engine comprises a print engine configured to print the translated electronic document data inclusive of a watermark identifying the web server in accordance with received watermark data.

7. The system of claim 3 further comprising:
a multifunction peripheral comprising the document processing engine and including a processor, memory and a data interface configured for data communication with the wireless data interface,
the multifunction peripheral configured to locally store data corresponding to at least one language filter,
the multifunction peripheral configured to receive electronic document data from the portable a device,
the multifunction peripheral configured to receive a translation instruction from the portable data device,
the multifunction peripheral configured to receive instruction data, and
the multifunction peripheral configured to apply locally stored language filter data specified by the translation instruction to the electronic document data to generate translated electronic document data; and
a document processing engine, and
wherein the data interface is configured to process translated electronic document data resultant from application of the locally stored filter data to the electronic document data via the document processing engine in accordance with received instruction data.

8. A method comprising:
receiving electronic document data into a data input;
receiving instruction data corresponding to at least one document processing operation to be performed on the electronic document data;
identifying, via a computer including a processor and associated memory, a language associated with the electronic document data;
receiving a translation instruction corresponding to at least one target language;
applying, via the computer, language filter data specified by the translation instruction to the electronic document data to generate translated electronic document data;
storing translated electronic document data resultant from application of the language filter data to the electronic document data in the memory; and
communicating the translated electronic document data to a document processing engine.

9. The method of claim 8 further comprising communicating the translated electronic document data and the instruction data to the document processing engine of a multifunction peripheral via a network interface.

10. The method of claim 8 further comprising receiving the electronic document data via a network interface of a web server comprising the computer.

11. The method of claim 8 further comprising receiving the electronic document data from an associated a portable data device via a wireless data interface.

12. The method of claim 11 further comprising:
receiving electronic document data from the wireless data interface via a network interface of a web server including a processor, memory and a data interface;
retrieving data stored in the web server memory corresponding to at least one language filter;
receiving the electronic document data from the portable data device via the network interface;
receive a translation instruction into the web server from the portable data device;
applying retrieved language filter data specified by the translation instruction to the electronic document data to generate translated electronic document data; and
communicating the translated electronic document data resultant from application of the language filter data to the electronic document data and watermark data corresponding to the web server to document processing engine.

13. The method of claim 12 further comprising completing a print operation on a multifunction peripheral using the translated electronic document data inclusive of a watermark identifying the web server in accordance with received watermark data.

14. The method of claim 11 further comprising:
receiving data from the wireless data interface into a multifunction peripheral comprising the document processing engine including a processor, and a memory;
storing data corresponding to at least one language filter in the multifunction peripheral memory;
receiving electronic document data from the portable device into the multifunction peripheral;
receiving a translation instruction from the portable data device into the multifunction peripheral;
receiving instruction data into the multifunction peripheral;
applying language filter data specified by the translation instruction in the multifunction peripheral memory to the electronic document data; and
processing translated electronic document data resultant from application of the locally stored filter data to the electronic document data via the document processing engine of the multifunction peripheral in accordance with received instruction data.

15. A system comprising:
a portable data device including a processor, a memory, a wireless data interface and a user interface,
the memory including filter data stored and watermark data,
the wireless data interface configured to receive electronic document data including text data corresponding to at least one language,
the processor configured to receive identity data identifying a language of the text data,
the user interface configured to receiving document processing instructions from an associated user,
the user interface configured to receive selection data corresponding to at least one target language; and
a print driver associated with a print engine of at least one remote document processing device,
the print driver configured to filter received electronic document data in accordance with stored language filter data in accordance with received selection data to generate translated electronic document data, and
the print driver configured to communicate the translated electronic document data, the watermark data and the document processing instructions to the print engine for rendering.

16. The system of claim 15 wherein the processor is further configured to receive supplementary language filter data from an associated data storage via the wireless data interface when no language filter data corresponding to at least a portion of the target language is stored in the memory.

17. The system of claim 16 wherein the processor is further configured to receive web server data corresponding to an identity of a webserver having filter data corresponding to the identity data and the selection data, and
wherein the processor is further configured to communicate the electronic document data and the document processing instructions to the web server for rendering of electronic document data translated by the web server in accordance with its filter data.

18. The system of claim 15 wherein the watermark data corresponds to an identity of a source of the filter data.

19. The system of claim 15 wherein the watermark data corresponds to an identity of the portable data device.

20. The system of claim 15 wherein the document processing instructions include print instructions for an associated multifunction peripheral.
